(19) United States
(12) Patent Application Publication
(10) Pub. No.: US 2020/0018113 A1
(43) Pub. Date: Jan. 16, 2020

(54) ADHESIVE WINDOW SHADE MOUNTING HARDWARE

(71) Applicant: AMH Design LLC, Lakewood, NJ (US)

(72) Inventor: Mordechai Tzvi Goldman, Lakewood, NJ (US)

(21) Appl. No.: 16/356,794

(22) Filed: Mar. 18, 2019

Related U.S. Application Data
(60) Provisional application No. 62/696,444, filed on Jul. 11, 2018.

(51) Int. Cl. E06B 9/266; E06B 9/262; B29C 65/00

(52) U.S. Cl. CPC E06B 9/266; E05Y 2900/148; B29C 66/437; E06B 9/262

(57) ABSTRACT

A window shade mounting bracket system that allows for hanging of window shades without the need to drill or nail the mounting brackets. The brackets have one or more adhesive pads for installing the brackets at a desired location and more or more extending arms that are configured to grip and retain various aspects of a window shade headrail.

### RELATED APPLICATIONS

This application claims the benefit of pending U.S. Prov. Application No. 62/696,444, filed Jul. 11, 2018, the contents of which are incorporated by reference herein.

### FIELD OF THE INVENTION

The invention relates to the field of window treatments, more specifically to adhesive mounting hardware that allows for window shade installation without the need for tools.

### BACKGROUND OF THE INVENTION

Window shades of all varieties are employed in houses and businesses all across the globe. Most typically, window shades include mounting hardware that is required to be nailed or screwed to a window frame. This requires skill and specialized tools. As a result, it is difficult for those who are unskilled, ill-equipped, elderly, infirm or injured to hang conventional window shades. There is, thus, a need for window shade mounting hardware that can be easily and quickly installed with minimal skill or effort and without the need for tools. There also is a need for window treatment mounting hardware that allows for easy installation of window shades on metallic, glass and similar surfaces that are not amenable for easy insertion of nails or screws.

### SUMMARY OF THE INVENTION

The invention described herein is directed to mounting hardware that is configured to hang any of a variety of common household window shades. In embodiments of the invention, mounting hardware is provided with an adhesive interface for adhering to a wall or similar surface, and a window shade engaging interface for securing a headrail or similar feature of a window shade.

### BRIEF DESCRIPTION OF THE DRAWINGS

Illustrative embodiments of the invention will hereafter be described with reference to the accompanying drawings, wherein like numerals denote like elements.

FIG. 1 is a front perspective view of a mounting bracket configured to hang a window shade on an outside of a window frame according to an embodiment of the invention.

FIG. 2 is a side perspective partial view of the window shade mounted on the mounting bracket of FIG. 2 according to an embodiment of the invention.

FIG. 3 is a schematic view of two cooperating mounting brackets of the type shown in FIG. 1 installed to mount a window shade according to an embodiment of the invention.

FIG. 4 is a perspective side view of a left inner frame mounting bracket according to an embodiment of the invention.

FIG. 5 is a perspective side view of a right inner frame mounting bracket shown separated according to an embodiment of the invention.

FIG. 6 is a schematic front view of a window frame shown with the bracket of FIG. 5 installed on a right side thereof and a segment of the bracket of FIG. 4 installed on a left side thereof.

FIG. 7 is an enlarged partial view of a window shade headrail positioned to be mounted on the right bracket of FIG. 6.

FIG. 8 is a partial view of a window shade in the process of being installed on the right bracket of FIG. 6.

FIG. 9 is a schematic view of a left inner bracket positioned to be inserted on a left end of headrail of a window shade.

FIG. 10 is a schematic view of a left side of a headrail with a left bracket segment installed on the left end, the headrail being positioned to be mounted to an inner frame.

FIG. 11 is a schematic view of two mounting brackets as shown in FIGS. 4 and 5, respectively, installed on inner surfaces of a window frame with a window shade suspended between the brackets according to an embodiment of the invention.

FIG. 12 is a side perspective view of a bracket for mounting a roller window shade according to an embodiment of the invention.

FIG. 13 is a side perspective view of a bracket used in combination with the bracket of FIG. 12 for mounting a roller window shade according to an embodiment of the invention.

FIG. 14 is a partial view of a roller shade positioned for insertion into in the bracket of FIG. 12.

FIG. 15 is a partial view of a roller shade positioned for insertion into in the bracket of FIG. 13.

FIG. 16 is a top perspective view of a hinge bracket for mounting a window shade according to an embodiment of the invention.

FIG. 17 is a top perspective view of a living hinge bracket for mounting a window shade according to an embodiment of the invention.

FIG. 18 is a schematic exploded view of the living hinge bracket of FIG. 17 positioned for installation in a window frame according to an embodiment of the invention.

FIG. 19 is a partial front view of a hinge bracket in use to secure a headrail according to an embodiment of the invention.

FIG. 20 is a side view of the hinge bracket of FIG. 19 shown in use.

### DETAILED DESCRIPTION OF THE INVENTION

Embodiments of the present invention will now be described with reference to the above-identified Drawings. However, the Drawings and the description herein are not intended to limit the scope of the claims. It will be understood that various modifications of the present description are possible without departing from the spirit of the invention. Also, features described herein may be omitted, additional features may be included, and/or features described herein may be combined in a manner different from the specific combinations recited herein, all without departing from the spirit of the invention.

As mentioned, embodiments of the invention provide window shade mounting brackets that are provided with surface-engaging adhesive contacts that allow attachment to surfaces via the adhesive contacts (such as for example adhesive pads). The brackets of the invention secure a window shade headrail or a window shade roll such that the shade portion of extends downward and substantially parallel to a window pane to be covered.

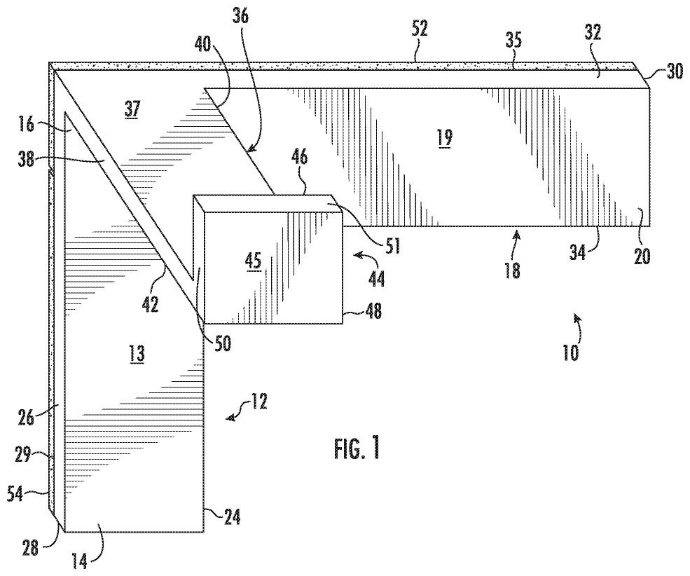

Referring to FIG. 1, a bracket 10 is shown that is configured to mount a window shade to a surface outside of a window frame. The bracket shown in FIG. 1 is a left bracket, whereas a substantially mirror image bracket is used to install on a right side of a window frame.

In embodiment of invention, bracket 10 has an “L-shaped” surface-engagement interface. For example, a vertical portion 12 having a lower end 14 and an upper end 16 is shown. A horizontal portion 18 is shown extending rightward from upper end 16 and terminating in right terminal end 20.

Right bracket 22 (shown FIG. 3) is substantially a structural and functional mirror image of bracket 10. As understood, the right bracket 22 has vertical portion that is joined to or formed integrally with a horizontal portion. The horizontal portion extends in a left direction and terminates in a left terminal end. In this regard, when cooperating right and left brackets 10, 22 are installed, their respective terminal ends of respective horizontal portions face one another and are disposed substantially parallel to each other.

Still referring to FIG. 1, in embodiments of the invention, vertical portion 12 has a front face 13, a right wall 24, a left wall 26, a bottom wall 28, and a rear wall 29. In embodiments of the invention, the thickness of right wall 24, left wall 26 and bottom wall 28 (which bridge front face 13 to rear wall 29) define the thickness of the vertical portion 12. Horizontal portion 18 has a front face 19, a right wall 30, an upper wall 32, a lower wall 34 and a rear wall 35. In embodiments of the invention, right wall 30, upper wall 32, and lower wall 34 (which bridge front face 19 to rear wall 35) define the thickness of the horizontal portion 18.

In embodiments of the invention, a window shade engaging interface is provided extending substantially orthogonally from the front face of the surface-engagement interface. For example, as shown in FIG. 1, an engaging arm 36 extends orthogonally from upper end 16 of vertical portion 12. It will be understood that engaging arm 36 may extend substantially orthogonally from any of various points on either vertical portion 12 or horizontal surface 18 in different embodiments of the invention.

In the embodiment shown, engaging arm 36 has a top surface 37, a left wall 38, a right wall 40 and an underside surface 42. Right and left wall 38, 40 which bridge top surface 37 to underside surface 42 define the thickness of engaging arm 36. In an embodiment, the terminal end of engaging arm 36 is turned upward to form an end stop 44. As shown, end stop 44 is a turned up segment of engagement arm 36 having an outer face 45 an inner face 46 and right and lefts walls 48, 50. An upper wall 51 forms the top surface of the end stop 44.

Still referring to FIG. 1, in embodiments of the invention, top surface 37 of engagement arm 36 extends contiguously from top wall 32 of horizontal portion 18; left wall 38 extends contiguously from left wall 26 of vertical portion 12; right wall 40 extends from front face 19 of horizontal portion 18; and underside surface 42 extends from upper segment 16 of vertical portion 12.

It will be understood that engagement arm 36 may be formed of any of various dimensions and/or sizes and shapes. In this regard, engagement arm 36 may be any of various platforms or surfaces that extend orthogonally from a bracket in the direction away from a window pane. Engagement arms of embodiments of the invention are sized and shaped to receive a bottom segment of a window shade headrail.

In addition, it will be understood that end stop 44 shown in exemplary only and that any of various appendages, or similar areas that serves as a physical barrier at the terminal end of an engagement arm may be provided in different embodiments of the invention.

In embodiments of the invention, the rear surface of the L-shaped surface-engagement interface (i.e. rear surfaces 29, 35 of vertical and horizontal portions 12, 18) is provided with adhesive material. For example, in the embodiment shown in FIG. 1, an upper adhesive pad 52 and a lower adhesive pad 54 are shown provided on the rear surfaces of L-shaped surface engagement interface.

In embodiments of the invention, the distance from side left wall 26 of vertical portion to right wall 30 of horizontal portion (e.g. length of bracket 10) is approximately 2.625″ and the distance from the upper wall 32 of horizontal portion 18 to lower wall 28 of vertical portion 12 (e.g. height of bracket 10) is approximately 2″. In embodiments of the invention, the distance from left wall 26 of vertical portion 12 to right wall 24 of vertical portion is approximately ⅝″. The distance from left wall 38 to right wall 40 of engagement arm 36 is approximately ⅝″. Similarly, the distance from upper wall 32 to lower of wall 34 of horizontal portion is approximately ⅝″. In embodiments of the invention, the distance between rear wall 35 and inner face 46 of end stop 44 (e.g. length of engagement arm 36) is approximately 1.5″. In embodiments of the invention, the end stop is approximately ⅕″ in height (e.g. as measured from underside surface 42 to upper wall 51 of end stop 44).

The one or more adhesive pads 52, 54 of the invention are provided with a removable backing that may be removed prior to installation. In embodiments of the invention, bracket 10 is provided with at least two adhesive pads, each of which configured to support three pounds of weight. Thus, each bracket is designed to support at least six pounds, and together, a pair of brackets may support at least 12 pounds of weight.

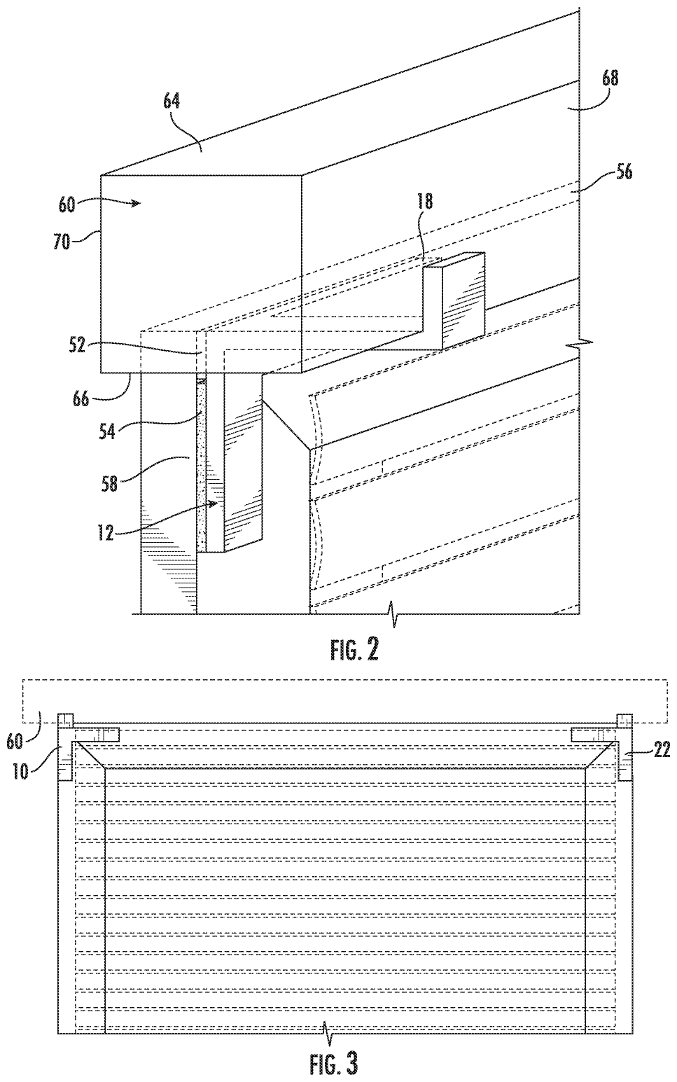

Bracket 10 is configured to be placed on an outside surface of a window frame. In this regard, the L-shaped surface engagement interface is configured to assist a user in placing the brackets in a level and even manner. For example, with reference to FIG. 2, a user may align the horizontal portion 18 with a top surface 56 of a window frame and align the vertical portion 12 with a side surface 58 of a window frame. In this manner, two brackets may be installed substantially in alignment with one another without requiring a tape measure, a level or a similar device.

It will be understood by those of ordinary skill in the art that L-shaped engagement surface provides numerous advantages in addition to providing a convenient “built-in” leveling system. For example, the combined surface areas of rear walls 29, 35 of vertical and horizontal portions 12, 18 provides increased surface area for adhesive material, thereby increasing the attachment strength of the brackets 10, 22. In addition, vertical member 12 serves as a buttress to support weight applied to engagement arm 36.

In embodiments of the invention, length of engagement arm 36 is sized to capture an average-sized headrail. That is, once installed on a window frame, a headrail fits between the wall and the end stop 44.

Referring to FIG. 2 a side view of a left bracket 10 is shown affixed to an outside surface of a window frame. As shown, horizontal portion 18 is substantially aligned with a horizontal window frame segment 56. Vertical portion 12 is substantially aligned with a vertical frame segment 58. Adhesive pads 52, 54 of L-shaped surface engagement interface are adhered to the horizontal and vertical frame segments 56, 58.

As shown, engagement arm 36 and end stop 44 form a window shade engagement interface. In this regard, engagement arm 36 is configured to receive a headrail of a window shade. For example, a headrail 60 is shown having an upper surface 64, and underside surface 66, a front wall 68 and a rear wall 70. Underside surface 66 of headrail is seated on front face 37 of engagement arm 36. Front wall 68 of headrail 60 is substantially parallel to inner wall 46 of end stop 44. Thus, end stop 44 and a wall surface substantially parallel thereto define a slot within which a headrail is placed.

As described, a second cooperating bracket (e.g. a right bracket 22) is provided for placement on a second side (e.g. right side) of a window frame. It will be understood that right bracket 22 is constructed as to substantially mirror the left bracket 10.

As shown in FIG. 3, a left bracket 10 is mounted on an upper left corner of a window frame and a right bracket 22 is mounted on an upper right corner of a window frame. A headrail 60 is seated on the two brackets 10, 22.

In order to install a window shade according to embodiments of the invention, a user first removes the liner from the one or more adhesive pads 52, 54 of left and right bracket 10, 22 to expose the adhesive material. Next, the user simply places the adhesive surfaces against a window frame or similar surface and applies pressure to firmly adhere the brackets 10, 22 to left and right sides, respectively, of a window frame. In embodiments of the invention, in order to determine a level placement of brackets, the user aligns horizontal portions 18 of brackets 10, 22 with a horizontal segment 56 of a window frame, and aligns respective vertical segments 12 of brackets 10, 22 with respective vertical segments 58 of a window frame. Next, the user places a headrail 60 whereby a left side of the headrail 60 rests on left bracket 10 and a right side of headrail 60 rests on right bracket 22.

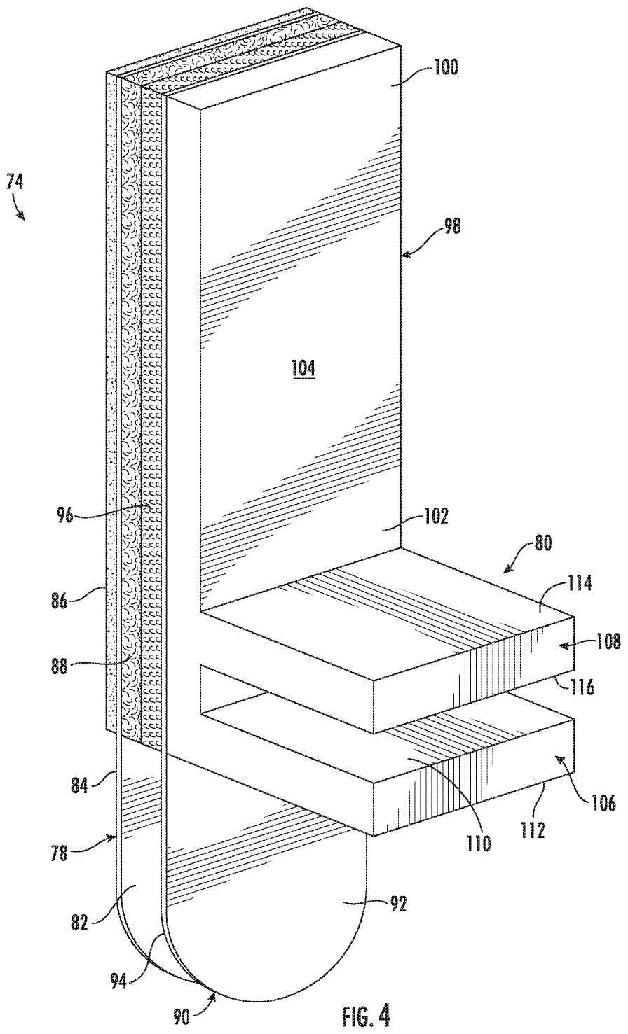

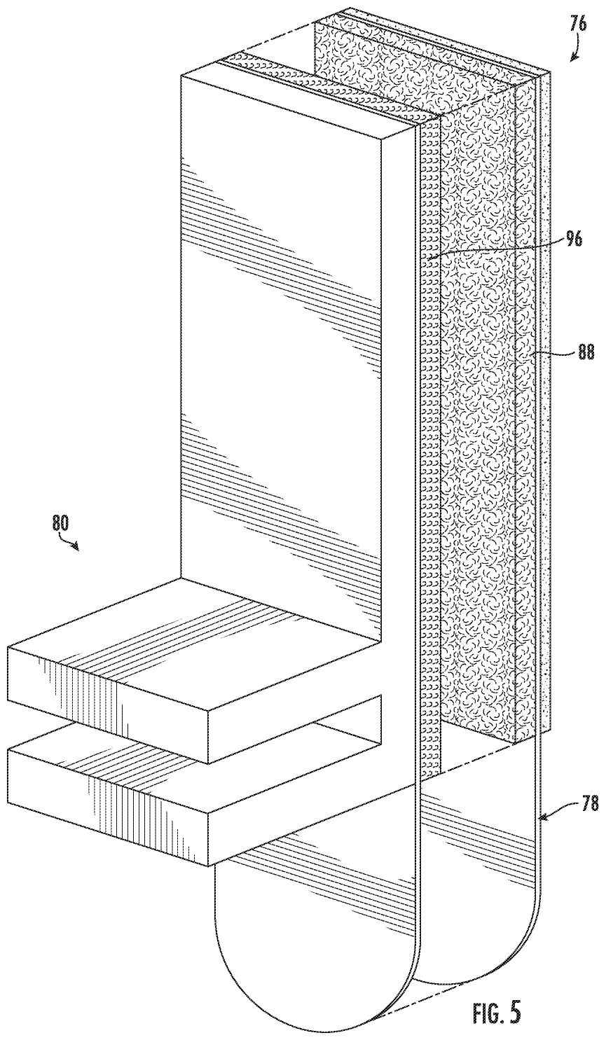

FIG. 4 shows a bracket configured to mount a window shade in an inside frame of a window. FIG. 4 shows a left bracket 74, whereas FIG. 5 shows a right bracket 76. It will be understood that left and right brackets 74, 76 are structural and functional mirror images of each other.

Referring to FIG. 4, bracket 74 is shown having a window frame engagement tab 78, and a window shade engagement bracket 80. Frame engagement tab 78 has a front surface 82, and a rear surface 84. Rear surface is coated with an adhesive material or is provided with an adhesive backing such as an adhesive pad 86.

Front surface 82 of tab 78 carries a fastening strip, such as for example a loops strip 88 of a Velcro temporary fastening system. As shown, loops strip 88 is attached to front surface 82 such that the loops carried thereon face forward.

In embodiments of the invention, a second tab 90 is provided having a front surface 92 and a rear surface 94. In embodiments of the invention, a fastening strip such as a hooks strip 96 of a Velcro temporary fastening systems is attached to the rear surface 94 of second tab 90. As shown, hook strip 96 faces loops strip 88 and are aligned in a substantially parallel manner.

As shown, a window shade engagement bracket 80 is attached to the front surface of second tab 90. Shade engagement bracket 80 is formed of a vertical member 98 having an upper end 100 and a lower end 102. Lower end 102 is provided with two prongs that emanate from a front surface 104 of vertical member 98.

For example, in embodiments of the invention, a first lower prong 106 is shown emanating from vertical member 98 and is disposed substantially orthogonally thereto. A second upper prong 108 is similarly shown emanating from vertical member in a substantially orthogonal fashion.

Lower prong 106 has an upper surface 110 and underside surface 112. Upper prong 108 has an upper surface 114 and an underside surface 116.

In embodiments of the invention the distance between upper surface 110 of lower prong 106 and underside surface 116 of upper prong 108 is substantially equal to or incrementally greater than a headrail lower wall to be mounted by brackets 74, 76.

Referring to FIG. 5, as a result of the Velcro (or similar) connection between window frame engagement tap 78 and second tab 90, the window frame engagement tab 78 can be separated from the bracket 76 by separating the respective Veclro fasteners 88, 96.

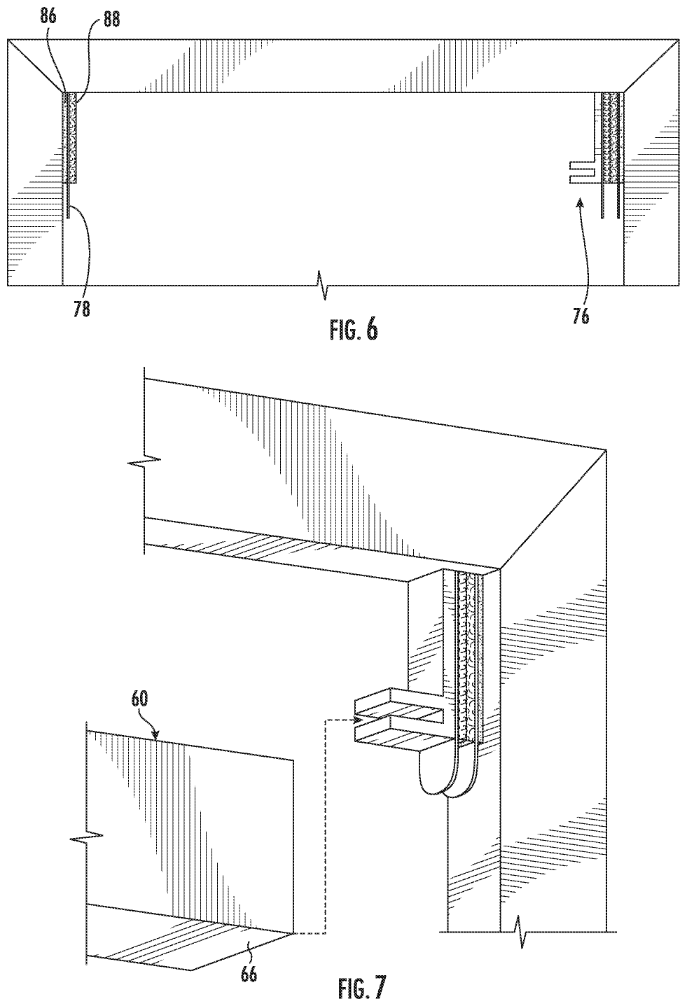

In use, and with reference to FIG. 6, a complete first bracket (e.g. right bracket 76) is installed in an upper right window frame. In this regard, any backing is removed to expose adhesive material and the user presses the adhesive material (e.g. adhesive pad 86) against the inside frame. Next, a window frame engagement tab 78, is separated from a window shade engagement bracket 80 of a second (e.g. left) bracket 74. The frame engagement tab 78 is adhered via adhesive pad 86 to the inner left window frame such that Velcro loops strip 88 is exposed and disposed facing right bracket 76.

Referring to FIG. 7, in an embodiment of the invention, a user then installs a lower surface 66 of a headrail 60 into the slot defined by upper and lower prongs 108, 106. For example, as shown in FIG. 8 a lower surface of a headrail is inserted into the space define by underside surface 116 of upper prong 108 and upper surface 110 of lower prong 106.

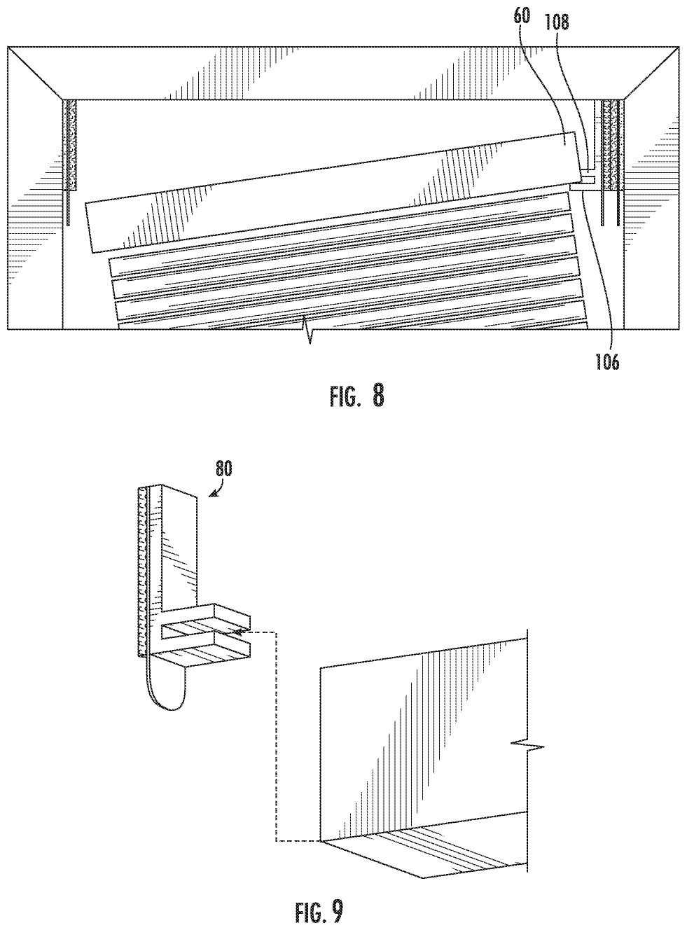

Referring to FIG. 9, a window shade engagement bracket 80 is installed to the second end of the headrail 60 to grasp the left underside surface of the headrail. With bracket 80 so installed, with reference to FIG. 10, a user then grips the free end (e.g. the left end) and pivots the free end upward to align hooks strip 96 of bracket 80 with loops strip 88 of frame engagement tab 78. Once the two hooks strip 96 engages with the loops strip 88—the left end of the headrail 60 is secured to the inner frame.

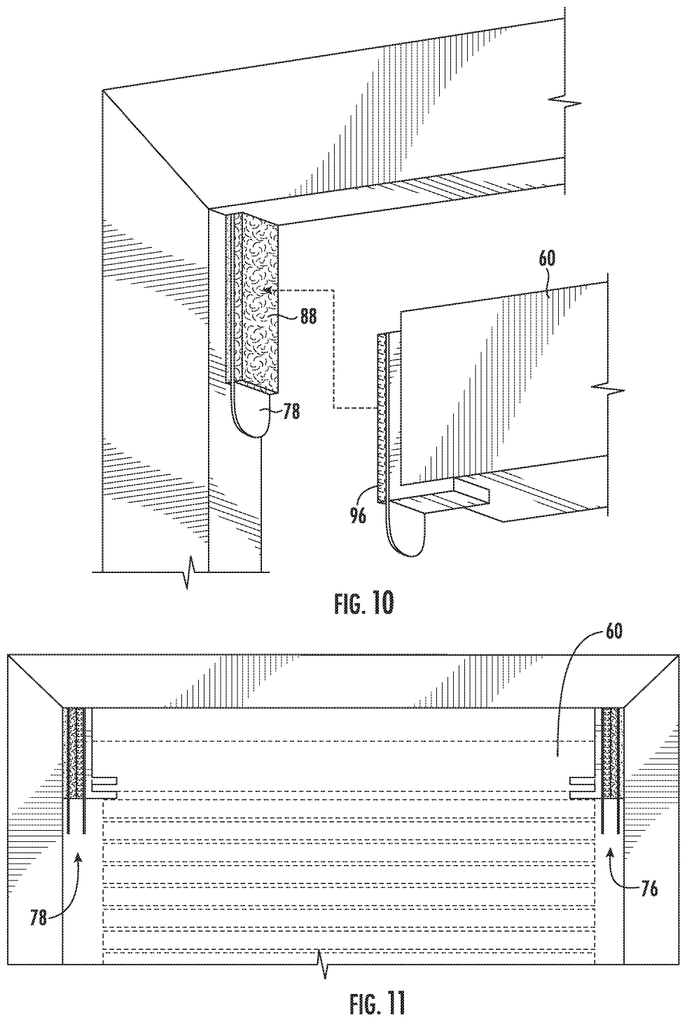

As shown, in FIG. 11, in this manner, a window shade is mounted between brackets 76, 78.

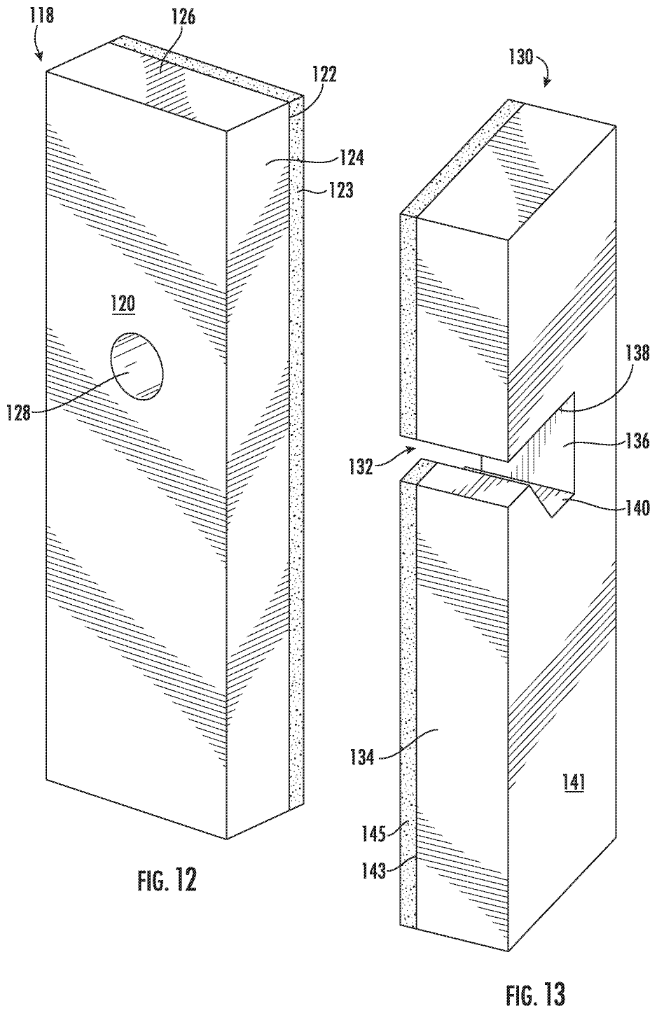

FIG. 12 shows a bracket for engaging a first end of roller shade, and FIG. 13 shows a bracket for engaging a second end of roller shade. As shown, in FIG. 12 a first roller shade bracket 118 has a front surface 120 and a rear surface 122. Sidewalls (e.g. right wall 124) and upper and lower walls (e.g. upper wall 126) define the thickness of bracket 118. The rear surface 122 is provided with adhesive material, such as for example, an adhesive pad 123 as shown.

As shown, a substantially circular hole 128 opens on the front surface of the bracket 118, traverses the thickness thereof and opens on the rear surface 122.

A cooperating bracket 130 is shown in FIG. 13. As shown, a bracket similarly dimensioned to bracket 118, having a front surface 141, a rear surface 143, sidewalls (e.g. 134) and upper and lower walls. In an embodiment, sidewall 134 has an opening 132 that leads to a slot 136 positioned orthogonally to opening 132. For example, as shown, slot 136 has an upper wall 138 and a substantially parallel lower wall 140. The rear surface 143 is provided with adhesive material, such as for example, an adhesive pad 145 as shown.

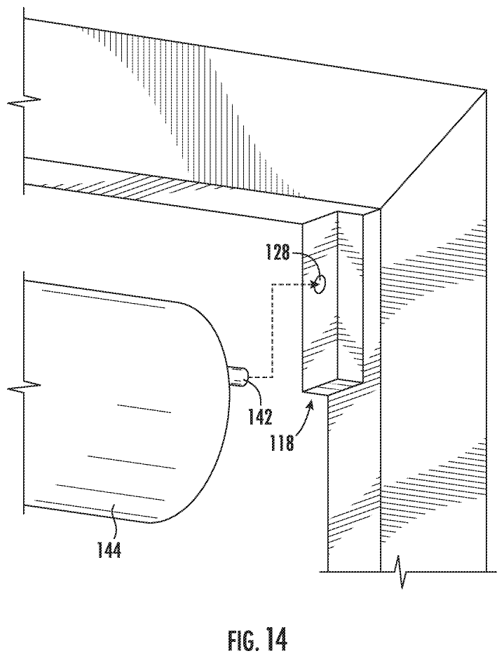

In use, and with reference to FIG. 14, bracket 118 is adhered to a first inner window frame segment (e.g. right post shown) via adhesive pad 123, and bracket 130 is adhered to a second inner window frame segment (e.g. left post shown) via adhesive pad 145. Next, a user inserts the end pin 142 of a roller shade 144 into circular hole 128 of bracket 118.

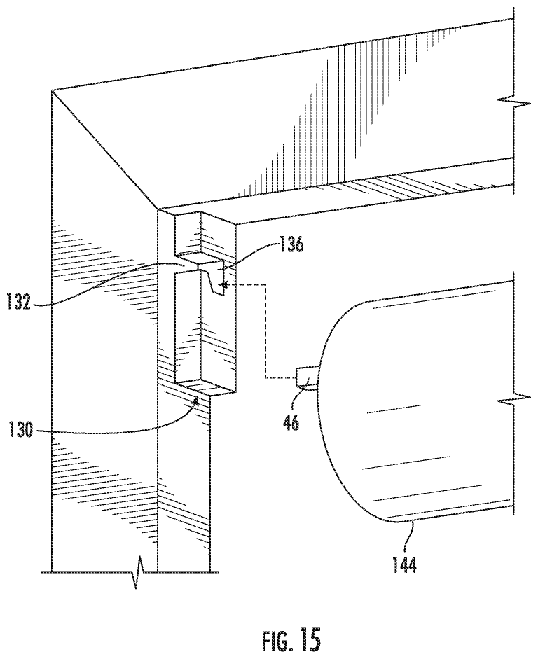

With reference to FIG. 15 a user then installs the post 146 of a roller shade 144 into a previously applied bracket 130. As shown, bracket 130 is installed with opening 132 facing forward. Thus, a user may inert post 146 and turn in until it rests within slot 136.

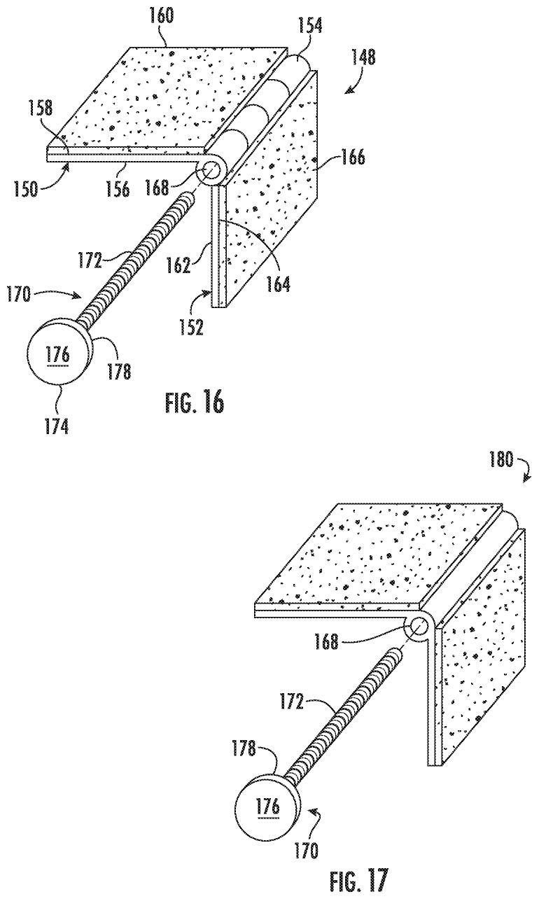

FIG. 16 shows a hinge bracket 148 that is configured to mount a window shade according to embodiments of the invention. Bracket 148 is formed of a first panel and a second panel that are disposed at a substantially right angle, where the first and second panel may each rotate with respect to each other about a joint. For example, as shown bracket 148 is formed of a first hinge leaf 150, a second hinge leaf 152, both of which are joined at hinge knuckle 154.

In embodiments of the invention, first hinge leaf 150 has an inside surface and an outside surface 158. Outside surface 158 is provided with an adhesive material. For example, in embodiments of the invention, an adhesive pad 160 is applied to outside surface 158 of hinge first hinge leaf 150.

In embodiments of the invention, second hinge leaf 152 has an inside surface 162 and an outside surface 164. Outside surface 164 is provided with an adhesive material. For example, in embodiments of the invention, a second adhesive pad 166 is applied to outside surface 154 of second hinge leaf 152.

In embodiments of the invention, a threaded channel 168 is provided within hinge knuckle 154 or at a similar juncture between first hinge leaf 150 and second hinge leaf 152. Threaded channel 168 is configured to receive a cooperating pin 170 or similar screw or post.

In embodiments of the invention, pin 170 has a shank section 172 and a head 174. In embodiments of the invention, shank section 172 is at least partially or entirely threaded. In embodiments of the invention, shank section 172 is at least as long as the length of channel 168, however, in other embodiments of the invention, shank section 172 is longer than the length of channel 168.

In embodiments of the invention, head 174 of pin 170 is a substantially round element such as ball or disk. Head has an outer surface 176 and an underside surface 178.

FIG. 17 shows hinge bracket 180 similar to that of FIG. 16. Hinge bracket 180 is formed of a living hinge made of plastic of similar flexible material.

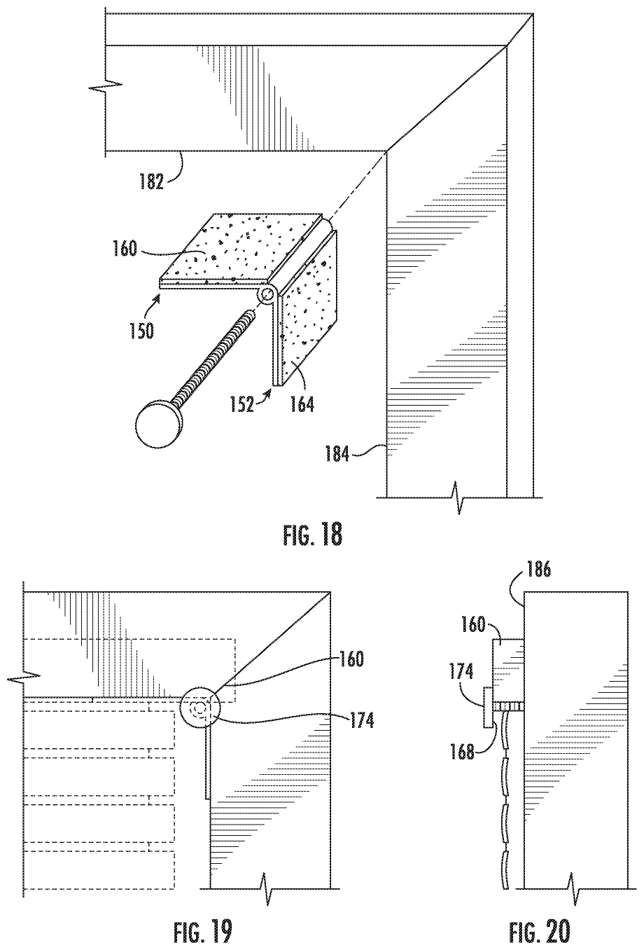

Referring to FIG. 18, to install a window shade, a user applies the adhesive pad 160 of first hinge leaf 150 to an underside of an upper window frame 182. The user applies second adhesive pad 152 associated with second hinge leaf 152 to a vertical (e.g. right) inner window frame 184.

The user then applies a second hinge bracket to a second upper corner (e.g. left) of an inner window frame.

It will be understood that first leaf 150 and second leaf 152 are movable with respect to each other such that they may form right angles or even acute or obtuse angles. Such flexibility allows the hinge bracket of embodiments of the invention to be installed in inner window frames even when the window frame upper corners do not form exact right angles.

With two hinge brackets installed in upper right and left corners of a window frame, a user inserts pins 170 so that they extend from channel 168 a distance that is greater than the length of a window shade headrail. Of course, if pins 170 were installed prior to mounting the brackets, the user may loosen pins 170 to make sure that underside surface 178 of head 176 is of a distance from opening of channel 168 that is greater than the width of headrail. A user then places a headrail on cooperating pins 170, whereby a first (e.g. left) end of a headrail rests on a first (e.g. left) pin and a second end (e.g. right) of the headrail rests on the second (e.g. right) pin. Thereafter, the user tightens both pins until they each underside surface 178 of respective heads 176 contact a front wall of the headrail.

For example, FIG. 19 shows a front schematic view of a window shade hung with hinge brackets according to embodiments of the invention. As show, head 176 contacts headrail 160 and secures it to the window.

FIG. 20 shows a side view of a window shade mounted with a hinge bracket according to embodiments of the invention. As shown, underside surface 168 of head contacts head rail 160 such that headrail 160 is gripped between head 176 and outer frame wall 186.

Embodiments of the invention allow for a secure attachment mechanism even without screws or nails. In the embodiments of FIGS. 16-20, a first panel and a second panel each provided with adhesive material adhere to a first surface and a second surface that is substantially orthogonal to the first surface. Such attachment from at least two sides allows for a stable attachment. Moreover, the first panel and second panel provide increased surface area allowing for increased areas of adhesive material, which additionally adds to the stability of the hinge brackets when installed inside a window frame.

While the present invention has been described with respect to exemplary embodiments, it will be appreciated that many modifications and variations may be made without departing from the true spirit and scope of the invention. It is, therefore, the intent of the present application to cover all such modifications and variations which fall within the true spirit and scope of the invention.

What is claimed is:

1) A window shade mounting bracket for installing a window shade to hang substantially parallel to a window pane, comprising:
a first portion having a front surface and rear surface;
a second portion having a front surface and a rear surface;
the first portion disposed substantially orthogonally to the second portion;
an arm extending from the first and second portion in a direction that is substantially orthogonal to the window pane; and
adhesive material disposed on the rear surface of the first portion and adhesive material disposed on the rear surface of the second portion.

2) window shade mounting bracket of claim 1, wherein the arm comprises an upper surface and an underside surface.

3) window shade mounting bracket of claim 2, wherein the arm comprises an end stop.

4) window shade mounting bracket of claim 3, wherein the end stop comprises a turned up terminal end of arm.

5) window shade mounting bracket of claim 1 whereby the first portion and the second portion form an L-shape.

6) window shade mounting bracket of claim 1, wherein the arm is movable.

7) window shade mounting bracket of claim 6, wherein the arm comprises a threaded pin.

8) window shade mounting bracket of claim 7, wherein the threaded pin comprises a disc.

9) A window shade mounting bracket for installing a window shade to hang substantially parallel to a window pane, comprising:
a first panel having an inner surface and an outer surface, the outer surface comprising adhesive material;
a second panel having an inner surface and an outer surface, the outer surface comprising adhesive material;
a channel disposed between the first panel and the second panel;
a pin that is sized and shaped to inert into the channel;
the pin comprising a head having an outside surface and an underside surface, whereby the underside surface comprises a disc that is configured to contact a headrail of a window shade.

10) window shade mounting bracket of claim 9, wherein the first panel, second panel and channel comprise a hinge.

11) window shade mounting bracket of claim 10, whereby the hinge is a living hinge.

12) window shade mounting bracket of claim 1 where the first panel is rotatable with respect to the second panel.

13) window shade mounting bracket of claim 1, wherein the channel comprises threads and the pin comprises threads.

14) A window shade mounting bracket for installing a window shade to hang substantially parallel to a window pane, comprising:
a first panel having an inner surface and an outer surface, the outer surface comprising adhesive material;
a second panel having an inner surface and an outer surface, the outer surface comprising adhesive material;
a threaded channel disposed between the first panel and the second panel, the threaded channel comprising a first length;
a pin that having a threaded shank segment and a head segment, whereby the head segment comprises a disc having an outer surface and an underside surface, the pin comprising a second length, whereby the second length is greater than the first length;
the pin insertable into the channel; and
whereby the shank segment of the pin is configured to receive a lower end of a headrail of the window shade and the underside surface of the head of the pin is configured to contact a front wall of a window shade headrail.
